(19) United States
(12) Patent Application Publication
(10) Pub. No.: US 2021/0360017 A1
(43) Pub. Date: Nov. 18, 2021

(54) SYSTEM AND METHOD OF DYNAMIC CYBER RISK ASSESSMENT

(71) Applicant: Cynomi Ltd, London (GB)

(72) Inventor: David Primor, Herzelia (IL)

(73) Assignee: Cynomi Ltd

(21) Appl. No.: 17/167,116

(22) Filed: Feb. 4, 2021

Related U.S. Application Data
(60) Provisional application No. 63/024,625, filed on May 14, 2020.

(51) Int. Cl. H04L 29/06; G06F 17/16

(52) U.S. Cl. CPC H04L 63/1433; G06F 17/16; H04L 63/145

(57) ABSTRACT

A computer system and a method for generating a dynamic cyber risk assessment are disclosed. The method receives data related to an organization network exposer to a possible cyber-attack, wherein the data is received from one or more external data sources and one or more internal data sources. The method processes the data to produce one or more measures for one or more data type, wherein a data type of the or more data type includes one or more parameters related to the organization network exposer to the possible cyber-attack; and calculates a cyber risk assessment vector of the organization based on one of the one or more measured data types.

### PRIORITY CLAIM

This application claims the benefit of priority to U.S. Provisional Patent Application Ser. No. 63/024625, filed Mar. 24, 2017, entitled “DYNAMIC CYBER RISK ASSESSMENT,” each of which is incorporated herein by reference in its entirety.

### TECHNICAL FIELD

Embodiments described herein generally relate to cyberattack and, more specifically, to an assessment of a cyber risk level.

### BACKGROUND

In computers and computer networks, a cyberattack attempts to expose, alter, disable, destroy, steal, or gain unauthorized access to or make unauthorized use of an asset. The cyberattack may be any offensive maneuver that targets computer information systems, infrastructures, computer networks, or personal computer devices.

For example, the cyberattack may be employed by sovereign states, individuals, groups, society, or organizations, and it may originate from an anonymous source. The cyberattack may steal, alter, or destroy a specified target by hacking into a susceptible system. Cyberattacks can range from installing spyware on a personal computer to attempting to destroy the infrastructure of entire nations. Cyberattacks have become increasingly sophisticated and dangerous. User behavior analytics and Security information and event management (SIEM) may help prevent these attacks and prevent damages to computers, computer networks, organizations, and the like.

### SUMMARY

Embodiments related to a system, a method and a product for generating a dynamic cyber risk assessment are described hereinbelow by the ways of example only.

One embodiment may include a method for generating a dynamic cyber risk assessment by a computer system comprising processing circuitry configured to process the method, the method comprising: receiving data related to an organization network exposure to a possible cyber-attack, wherein the data is received from one or more external data sources and one or more internal data sources; processing the data to produce one or more measures for one or more data types, wherein a data type of the or more data type includes one or more parameters related to the organization network exposure to the possible cyber-attack; and calculating a cyber risk assessment vector of the organization based on one of the one or more measured data types.

For example, the method may calculate a score to the data type m by a risk assessment algorithm, wherein the calculation is done according to:

Aₘ=LₘSₘIₘ

Where:

Lₘ—is the likelihood to initiate attack m,

Sₘ—is the likelihood of attack success; and

Iₘ—is the impact of the attack.

For example, the method may estimate the contribution of a data type m to a cyber-attack risk estimation by assuming that if A is a vector of the attack risks, and R is a vector of a total organization risk, then

$$\underline{R} = \frac{1}{N} \underline{{A}^{T}} W$$

Wherein:

W—is a weight matrix that maps between risk attacks to total operational or business risks:

$$[ \begin{matrix}{W}_{1 , 1} \\ {W}_{1 , 2} … \\ {W}_{1 , M}\end{matrix} ]$$

For example, the processing may be done by a risk assessment algorithm and comprises: providing a security protection score to the data type based on a portion of the received data collected by an automated questionnaire.

For example, the processing may be done by the risk assessment algorithm and comprises: providing an impact assessment as a measure of a cyber-attack risk impact based on the automated questionnaire inputs.

For example, the processing comprises receiving a cyber-attack type, generating one or more cyber-attack vectors by processing the cyber atteck type by the risk assessment algorithm.

For example, the processing may be done by the risk assessment algorithm and comprises: receiving attacker view information data, protection measures data, organization profile data.

For example, the processing may be done by the risk assessment algorithm and comprises: calculating the likelihood of the cyber-attack measure based on the attacker view information data.

For example, the processing may be done by the risk assessment algorithm and comprises: calculating a likelihood of a predefined cyber attack to success based on the protection measure data.

For example, the processing may be done by the risk assessment algorithm and comprises: calculating a likelihood of a cyber attack to success based on an external statistical calculation.

For example, the processing may be done by the risk assessment algorithm and comprises: calculating a total risk of cyber-attack based on the likelihood of an attack-type to success and an attack impact on the organization vector.

For example, the method may include calculating a motivation of an attacker to perform a cyber attack on the organization based on a potential attacker interest indicator and an attacker view indicator.

For example, wherein the motivation of the attacker comprises one or more levels of motivation.

One other embodiment may include a product comprising one or more tangible computer-readable non-transitory storage media comprising program instructions for generating a map of subsurface utilities, wherein execution of the program instructions by one or more processors comprising: receiving data related to an organization network exposure to a possible cyber-attack, wherein the data is received from one or more external data sources and one or more internal data sources; processing the data to produce one or more measures for one or more data types, wherein a data type of the or more data type includes one or more parameters related to the organization network exposure to the possible cyber-attack; and calculating a cyber risk assessment vector of the organization based on one of the one or more measured data types.

For example, execution of the program instructions by one or more processors comprising: calculating a score to the data type m by a risk assessment algorithm, wherein the calculation is done according to:

Aₘ=LₘSₘIₘ

Where:

Lₘ—is the likelihood to initiate attack m,

Sₘ—is the likelihood of attack success; and

Iₘ—is the impact of the attack.

For example, execution of the program instructions by one or more processors comprising: estimating the contribution of a data type m to a cyber-attack risk estimation by assuming that if A is a vector of the attack risks, and R is a vector of a total organization risk, then

$$\underline{R} = \frac{1}{N} \underline{{A}^{T}} W$$

Wherein:

W—is a weight matrix that maps between risk attacks to total operational or business risks:

$$[ \begin{matrix}{W}_{1 , 1} \\ {W}_{1 , 2} … \\ {W}_{1 , M}\end{matrix} ]$$

One other other embodiment may include a computer system for generating a dynamic cyber risk assessment comprising processing circuitry which is configured to:

receive data related to an organization network exposure to a possible cyber-attack, wherein the data is received from one or more external data sources and one or more internal data sources; process the data to produce one or more measures for one or more data types, wherein a data type of the or more data type includes one or more parameters related to the organization network exposure to the possible cyber-attack; and calculate a cyber risk assessment vector of the organization based on one of the one or more measured data types.

For example, the processing circuitry is configured to: calculate a score to the data type m by a risk assessment algorithm, wherein the calculation is done according to:

Aₘ=LₘSₘIₘ

Where:

Lₘ—is the likelihood to initiate attack m,

Sₘ—is the likelihood of attack success; and

Iₘ—is the impact of the attack.

For example, the processing circuitry is configured to: estimate the contribution of a data type m to a cyber-attack risk estimation by assuming that if A is a vector of the attack risks, and R is a vector of a total organization risk, then

$$\underline{R} = \frac{1}{N} \underline{{A}^{T}} W$$

Wherein:

W—is a weight matrix that maps between risk attacks to total operational or business risks:

$$[ \begin{matrix}{W}_{1 , 1} \\ {W}_{1 , 2} … \\ {W}_{1 , M}\end{matrix} ]$$

For example, the processing circuitry is configured to process a risk assessment algorithm to: provide a security protection score to the data type based on a portion of the received data collected by an automated questionnaire provide an impact assessment as a measure of a cyber-attack risk impact based on the automated questionnaire inputs; receive a cyber-attack type, and to generate one or more cyber-attack vectors based on the cyber-attack type; receive attacker view information data, protection measures data, organization profile data and calculate the likelihood of the cyber-attack measure based on at least one of the attacker view information data; calculate a likelihood of a predefined cyber attack to success based on the protection measure data; calculate a likelihood of a cyber attack to success based on an external statistical calculation; and calculate a total risk of cyber-attack based on the likelihood of an attack-type to success and an attack impact on the organization vector.

It is understood from the present disclosure described a solution for shortcomings in the field of the art. More specifically, the embodiments described herein enable the generating of a map of subsurface utilities by a system that periodically calculates tolerance boundaries of one or more sections of a subsurface utility line based on data received from a plurality of data sources.

### BRIEF DESCRIPTION OF THE DRAWING

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic illustration of a block diagram of a system configured to assess a cyber-attack risk, in accordance with some demonstrative embodiments.

FIG. 2 is a schematic flowchart illustration of a method of a risk algorithm, in accordance with some demonstrative embodiments.

FIG. 3 is a schematic illustration of a method visualization of a clustering algorithm for classifying a likelihood of an attacker to perform a cyberattack, in accordance with some demonstrative embodiments.

FIG. 4, which is a schematic illustration of a product of manufacture 400, according to some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing,” “computing,” “calculating,” “determining,” “establishing,” “analyzing,” “checking,” or the like, may refer to operation(s) and/or process(es) of a computer, a computing platform, a computing system, or other electronic computing devices, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality,” as used herein, include, for example, “multiple” or “two or more.” For example, “a plurality of items” includes two or more items.

The term “organization,” or “organisation” as used herein is an entity such as, for example, a company, an institution, and/or an association comprising one or more people and having a particular purpose.

The term “Ryuk ransomware,” as used herein, is related to a cyber methodology for targeting large organizations for a high-ransom return.

The term “DNS flood” as used herein, is related to a type of Distributed Denial of Service (DDOS) attack in which the attacker targets one or more Domain Name System (DNS) servers belonging to a given zone, attempting to hamper resolution of resource records of that zone and its sub-zones.

References to “one embodiment,” “an embodiment,” “demonstrative embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified, the use of the ordinal adjectives “first,” “second,” “third,” etc., to describe a common object merely indicate that different instances of like objects are being referred to and are not intended to imply that the objects so described must be in a given sequence, either temporally, spatially, in ranking, or in any other manner.

Some embodiments may be used in conjunction with various devices and systems, for example, a Personal Computer (PC), a desktop computer, a mobile computer, a laptop computer, a notebook computer, a tablet computer, a server computer, a handheld computer, a wireless communication device, a wireless Access Point (AP), a wired or wireless router, a wired or wireless modem, a wired or wireless network, a Local Area Network (LAN), a Wireless LAN (WLAN), and the like.

Some demonstrative embodiments may include a system and a method for generating a dynamic cyber risk assessment. The method may generate a set of cyber security risk measures according to the internal and/or external environment of an organization. The cyber secRisk measures may be calculated statistically based on a set of data collected, both from the organization and from known cyber threats.

In some demonstrative embodiments, the resources of the organization and processes may be continuously changed. Thus the data input for the algorithm is time-dependent. For example, external cyber threats data may constantly change mostly due to new methods and improvements in cyber attacks.

Advantageously, cyber risk modeling, e.g., accurate cyber risk modeling, may bring significant business benefits. For example, accurate cyber risk modeling may allow an organization to assign a budget and resources for cyber risk mitigation, seek insurance coverage to protect unmitigated risk, and enforce a plurality of business decisions.

In some demonstrative embodiments, the method may include a set of connected modules. For example, the modules may be built to provide risk calculation results to achieve maximum accuracy of risk calculation results, e.g., 80% to 100% accuracy.

In some demonstrative embodiments, the method for generating a dynamic cyber risk assessment may include three phases: a data collection phase, a preprocessing phase, and a risk assessment phase. It should be understood that the three phases method is an example only, and other methods may be used, for example, one phase method, two phases method, four phases methods and etc.

In some demonstrative embodiments, the data collection phase may be based, for example, on the three following components:
1. General public information component. For example, the general public information component may include best practices and generic research that may be used as an input for generating a Methodology database and/or an Attacker Threat (AT) database.
2. Organization-specific data component. For example, The organization-specific data component may collect data through an automated questionnaire and may include the organization profile, evaluation of current organizational security controls, and one or more of the organization business risks
3. Information Technology (IT) scanning component. For example, the IT scanning component may include an IT scan of the external network of the organization to receive data of a profile of an attacker. The data, e.g., the profile of the attacker, may be added to the AT database.

In some demonstrative embodiments, during the preprocessing phase, the collected data in the data collection phase may be processed, for example, by at least the three following modules: a Protection Score (PS) module, an Impact Assessment (IA) module and/or an Attacker View (AV) module.

In some demonstrative embodiments, the PS module may be configured to calculate scores for different security subdomains of the organization, such as, for example, a workstation and/or email security. For example, the calculated scores may be based on the data stored at the Methodology database, and/or the AT database, and/or evaluation of the data of the organization collected from the automatic questionnaire.

In some demonstrative embodiments, the IA module may be configured to process the organization's business risk evaluation data, together with the AT database data, to generate an estimated impact for the different attack scenarios.

In some demonstrative embodiments, the AV module may be configured to process the external IT scanning results and/or the organization's internal information from the plurality of questionnaires. The AV module may be configured to calculate an attacker view score of the organization based on the organization's internal information. The AV module may be configured to generate data representing the organization's information that can be accessible to an attacker with reasonable effort during the attack reconnaissance phase.

In some demonstrative embodiments, the main risk algorithm module may be configured to calculate a cyber risk assessment vector, e.g., a score vector, of the organization based on the attacker view score and/or other outputs of the plurality of the preprocessing modules.

In some demonstrative embodiments, the cyber risk assessment may include a collection of cyber risks that are suited to the cyber-attack risk profile of the organization. For example, the main risk algorithm module may be configured to use one or more, e.g., a set of, algorithms to calculate at least: a probability of an attack type, e.g., each attack type, on the organization, a probability of attack success, and a probable attack impact, if desired.

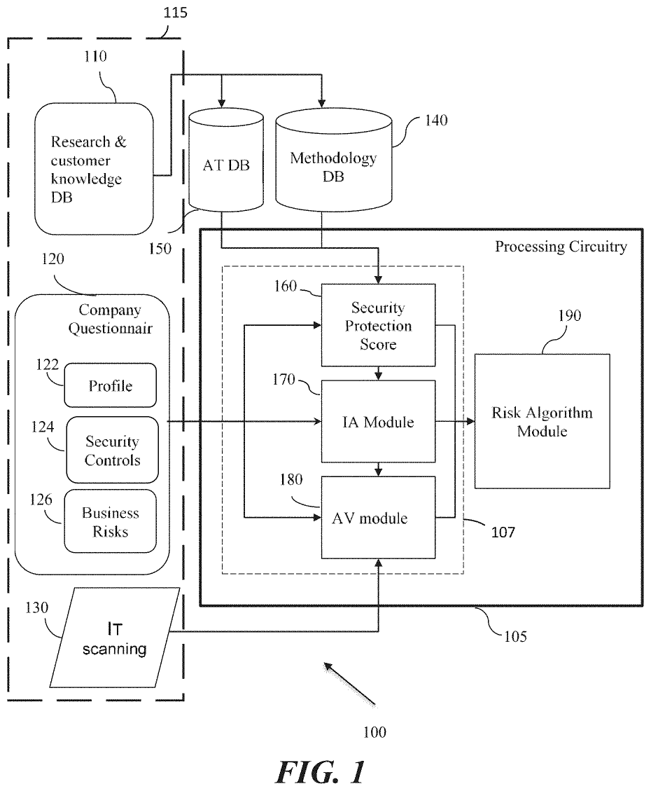

Referring first to FIG. 1, a schematic illustration of a block diagram of a system 100 to provide a dynamic cyber risk assessment, in accordance with some demonstrative embodiments.

In some demonstrative embodiments, for example, the system 100 includes processing circuitry 104, a research and knowledge database 110, an automated questionnaire unit 120, an IT scanning unit 130, a methodology database 140, and an AT database 150.

In some demonstrative embodiments, the research and knowledge database 110, the automated questionnaire unit 120, and the IT scanning unit 130 may be included in a data collection component 115.

In some demonstrative embodiments, research and knowledge database 110 may include external security data. The external security data can be taken from the Internet open sources, for example, recent cyber attacks methods, new cyber-attack methods, publications from leading cyber industrial leaders such as, for example, cyber companies, e.g., Check-Point® and/or national information from the Cyber Emergency Response Team (CERT) or the like.

In some demonstrative embodiments, the automated questionnaire unit 120 may include internal security data. The internal security data results from the answers to the automated questionnaire. For example, a combination of the National Institute of Standards & Technology (NIST) cyber methodology and/or the cyber methodology of the national cyber directorate organization or the like. It should be understood that other cyber methods can be used with some other embodiments.

In some demonstrative embodiments, IT scanning unit 130 may perform a scan on the public network and/or other external networks by external scanning algorithms such as, for example, NMAP. For example, the NMAP algorithm may search for open ports, vulnerably exposed servers, and/or communication protocols, such as, for example, SSH, RDP, HTTP, and the like.

For example, the external security data may be taken as an input to the data collection component 115.

In some demonstrative embodiments, the external security data may include a set of security measures and best practices measures, based on known methodologies such as, for example, ISO 27001 and/or NIST and/or any other proprietary methodologies. The data input may be normalized according to a set of requirements, as described below.

In some demonstrative embodiments, the Methodology DB 140 may include one or more sections, e.g., 15 sections. For example, the sections may include, for example, a workstation security section, a server security section, an email security section, an access control section, a network security section, an incident response section, a recovery section, a logging and monitoring section and etc.

In some demonstrative embodiments, a section, each section, may include a general policy with statements to be implemented by the organization. For example, the workstation section may include a plurality of statements, e.g., 15 statements. For example, “Workstation should be locked after 15 minutes of inactivity”. The organization's Chief Information Security Officer (CISO) may create these sections and statements by taking the statements in the NIST cyber methodology and the cyber directorate methodology, e.g., the Israel national cyber directorate methodology. The organization's CISO may make adaptations according to the requirements and according to the size of the organization, e.g., small and/or medium and/or large organization. The sections, e.g., all the sections, are the normalized input of the Methodology DB 140. Each subsection includes a general policy with statements to be implemented by the organization as described above.

In some demonstrative embodiments, the AT DB 150 may be implemented by using the cyber threats data as an input. The cyber threat data may be, for example, a ransomware attack such as, for example, Ryuk ransomware and/or a DDOS attack such as, for example, DNS flood. It should be understood that any cyber threat data and/or cyber-attack data can be taken as an input as long as, for example, data, e.g., all data, required fields exist. These fields may include, for example, a possible attack entry field, e.g., RDP port and/or phishing Email, a main attack result field, e.g., file encryption, and an open research statistics field. For example, the probability of the small and medium organizations to be cyber-attacked may be taken from the open research statistics field

In some demonstrative embodiments, the AT DB 150 may include a dedicated cyber threats database. For example, the dedicated cyber threats database may be generated by adding all threat and attack data to a JavaScript Object Notation (JSON) typed table. This database may be used, for example, for calculating a probability of attack type versus an organization profile and/or security posture.

In some demonstrative embodiments, automated questionnaire 120 may be used to determine internal the organization data, which can not be achieved from an external search. For example, the automated questionnaire 120 may include an automated questionnaire mechanism that collects at least three types of data, such as, for example, organization profile data 122, security controls data 124, and/or business risk data 126.

In some demonstrative embodiments, organization profile data 122 may include, for example, a number of employees, an organization sector, e.g., the medical sector, and site distribution sector. It is assumed that the motivation of an attacker may depend on probable profit. Thus, organization profile data 122 may be needed for cyber risk estimation. The organization profile data 122 may be calculated by using, for example, a clustering algorithm.

For example, the clustering algorithm may map between organization characteristics, e.g., business type, customers, product, employee number, etc., and the one or more profile groups of the organization.

For example, the organization characteristics may be collected by answering the questionnaire online using a Software as a Service (SaaS) platform, if desired.

In some demonstrative embodiments, a profile group,e.g., each profile group, may have a range of values for all different organization characteristics. For example, a small financial group may be defined with an average of 20 employees, and a financial sector organization may be defined with an average of $10M annual review. It should be understood that any number of profile groups can be defined.

In some demonstrative embodiments, for each organization, the algorithm picks the “closest” profile group by comparing all possible profile group distances wherein the distance is the square distance between the organization's characteristic value and the average characteristic value of each group.

The algorithm operates as follows: For M characteristic values and N profile groups, the algorithm finds the minimum square sum of distances between the organization characteristic values and the group profile characteristic values:

minₙΣₘ₌₁^{M}(a_{n,m}−a_{0,m})², Equation 1

### Where:

n=1 . . . N, the group profile number, and

m=1 . . . M is the characteristic value.

In some demonstrative embodiments, security controls data 124 may provide an organization security control evaluation. For example, specific data may be related to the use of IT security tools. For example, the password complexity and existence of Email two-factor authentication and procedures may be collected through questions adjusted to a methodology framework.

In some demonstrative embodiments, the questions may be taken from a collection of an online questionnaire that goes over recommended tools and procedures based on a modification of, for example, the NIST cyber recommendations, the national cyber methodology recommendation, and the organization CISO best practices. The collected data may be used later in the security control assessment module if desired.

In some demonstrative embodiments, business risk data 126 may include detailed information about the organization's business and concerns, which may be used in the impact analysis by the impact analysis module 170. The business risk data 126 is part of risk prioritization.

In some demonstrative embodiments, IT scanning unit 130 may be an automated cloud-based IT external scan that is performed on the organization data. For example, the external scan may be done by using open-source tools such as, for example, Network Mapper (NMAP) and/or Shodan search engine.

In some other demonstrative embodiments, the scan of the organization data may be done by using a combination of several open-source scripts, for example, for finding Remote Desktop Protocol (RDP) protocol vulnerabilities. A general fast scan may be done first to find the RDP port, and according to the scan result, a more detailed vulnerability scan may be done for the RDP port with an additional NMAP script with different parameters.

In addition, the automated IT scan may be done to locate potential software and hardware vulnerabilities such as, for example, open TCP/UDP ports. The automated IT scan may search for social information on employees that are exposed to public domains and social networks. The output of the IT scanning unit 130 may be used to calculate the attacker view score by attacker view module 180.

In some other demonstrative embodiments, the processing circuitry 105 may include a set of modules and algorithms to implement the input values for the risk assessment main algorithm.

In some other demonstrative embodiments, the processing circuitry 105 may include a security protection score module 160, an Impact Assessment (IA) module 170, an Attacker View (AV) module 180, and a Risk Algorithm (RA) module 190. Although it should be understood that this is an example only and in other embodiments, the processing circuity 105 may include more and/or less and/or others modules and algorithms to assess the risk of a cyber attack. It should be understood that IA module 170, AV module 180, and RA module 190 may be implemented by software, hardware and/or any combination of software and hardware.

In some demonstrative embodiments, security protection score module 160 may be configured to provide security protection measures, e.g., scores, based on the Methodology DB 140 data. However, in other demonstrative embodiments, security protection score module 160 may use other data and/or data sources to provide security protection scores.

The probability of attack success highly depends on the security protection of the organization. The security protection score is based on the Methodology DB data, which is based, for example, on the combination of NIST cyber methodology with the national cyber directorate methodology and the organization CISOs best practices.

In some other demonstrative embodiments, security protection score module 160 may be configured to provide a security protection score based on the data collected by using the questionnaire and an initial estimation of each subsection security. The security score may be periodically updated based on new information gathered from the user and/or IT scanning input from integrated security tools.

In some demonstrative embodiments, IA module 170 may be configured to provide an impact assessment as a measure of the risk impact based on the dedicated questionnaires by a risk assessment algorithm. The dedicated questionnaires may ask the level of attack concern on one hand and the existence of sensitive and/or private data on the other hand, together with the organization sector and the previous attack impacts of similar organizations. The impact assessment of an attack-type, e.g., each attack type, may be estimated by the risk assessment algorithm.

In some demonstrative embodiments, the risk assessment algorithm may generate one or more attack vectors. For example, an attack vector, e.g., each attack vector, may include, for example, five levels of impacts, wherein the five levels of impacts may include a critical impact, a very high impact, a high impact, a medium impact, and/or a low impact. For example, the impact level may be defined by using a weighted sum of an average organization profile, the existence of sensitive data, and an organization concern data.

In some demonstrative embodiments, the AV module 180 may be configured to calculate a total score value based on the external scan output and internal information gathered from the questionnaire answers. The motivation of an attacker depends on its initial estimation of success. This is usually done by an attack reconnaissance phase and includes gathering information on employees, organization systems, and IT infrastructure. In many cases, the attacker's view is highly dependent on exposure to the Internet and infrastructure possible vulnerabilities.

In some demonstrative embodiments, the AV module 180 may be configured to calculate a total score value by calculating the level of external scan findings, such as, for example, two critical findings and four high-level findings, and add questionnaire answers findings related to the attacker view. For example, the questionnaire finding may include the type of operating systems, communication devices, and the like.

In some demonstrative embodiments, preprocessing components 107 may include the security protection score module 160, the IA module 170, and AV module 180. The results of the preprocessing components 107 may be inputted to the risk algorithm module 190.

In some demonstrative embodiments, the risk algorithm module 190 may be configured to receive data from at least one of the preprocessing components 107 and to generate a collection of cyber risks based on the risk profile of the organization.

In some demonstrative embodiments, risk algorithm module 190 may be configured to use a set of algorithms to calculate the probability of the attack type on the organization, e.g., each attack type, the probability of attack success, and/or the probable attack impact.

In some demonstrative embodiments, the total cyber risk to cyber-attack may be divided into one or more groups. A group of one or more groups, e.g., each group, may include different cyber risk/attack types. For example, a cyber risk/attack type may include website defacement, a file deletion, data leakage and etc.

In some demonstrative embodiments, risk algorithm module 190 may be configured to calculate one or more cyber attack risks by using a statistical algorithm that determines the probability of the cyber attack risk to happen and the possible impact of the cyber attack. The cyber-attack risk assessment may be continuously changed based on the change in the cyber attack vectors. The cyber-attack vectors may be dynamic and may influence the effectiveness of the organization's cyber protection tools and procedures.

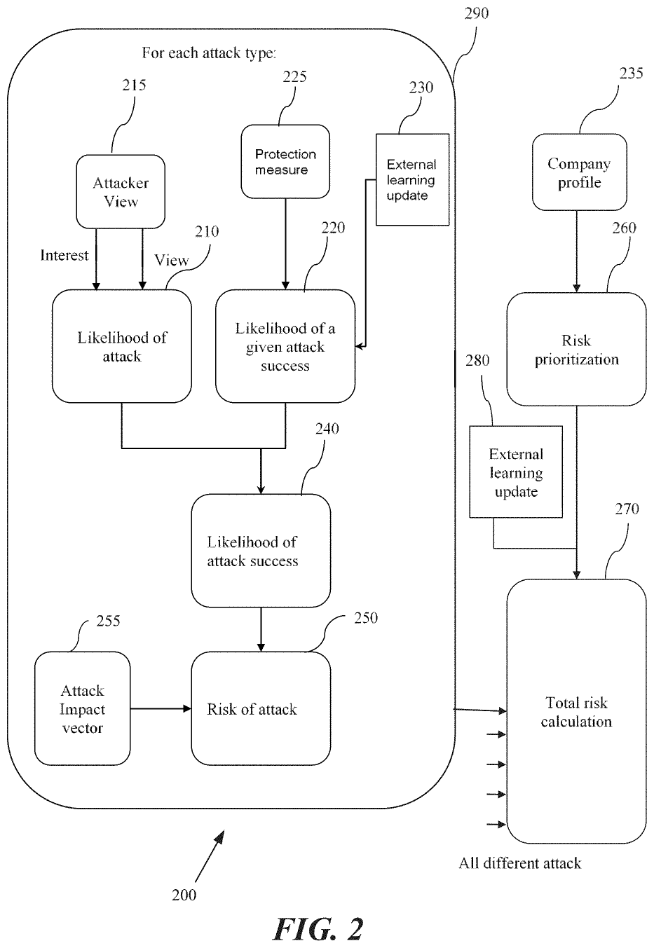

Reference is now made to FIG. 2, a schematic flowchart illustration of a method of a risk assessment algorithm 200, in accordance with some demonstrative embodiments. It should be noted that the portion of risk assessment algorithm 200 that framed with by frame 290 may be employed to one or more cyber attack types, e.g., each cyber-attack type.

In some demonstrative embodiments, the risk assessment algorithm may be executed by risk algorithm module 190 (FIG.1). The data inputs for the algorithm may include three preprocessing components: an attacker view information 215, a protection measures 225, and/or an organization profile 235.

In some demonstrative embodiments, the attacker view information 215 may be used to generate the likelihood of the attack (text box 210). It may be done by using, for example, two indicators—a potential attacker interest data (left arrow) and an attacker view data (right arrow).

For example, the cyber attack potential interest data may be based on the organization profile and the cyber-related threats associated with this profile.

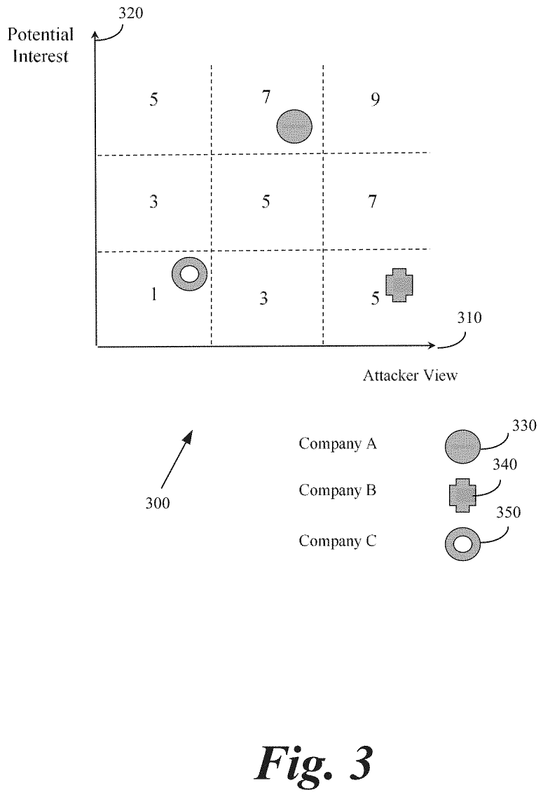

For example, the attacker view indicator data may reflect the estimation of success of the attacker based on an external scan and publicly available organization information. The Attacker motivation may be estimated via a clustering algorithm which divides the estimated value range into one or more discrete values, e.g., nine discrete values. As a result, a two-dimensional clustering map is produced, taking the two above indicators into account, as described below in FIG. 3.

In some demonstrative embodiments, a likelihood of given attack success (text box 220) may be calculated based on the protection measure input data 225. For example, the likelihood of a given attack success (text box 220) may be calculated when the cyber-attack is initiated.

Furthermore, in some demonstrative embodiments, a likelihood of given attack success (text box 220) may be calculated based on an external statistical calculation (text box 230), taking into account different attack types, success rates of the cyber attack, the cyber attack methods used by the attacker, and the organization vulnerability that was used to enable the cyber attack. Using these statistics makes it possible to determine the probability of attack success given the security control status.

In some demonstrative embodiments, a total risk of attack may be calculated (text box 250) from a combination of the likelihood of initiating an attack (text box 210) and the likelihood of attack success (text box 220), which may be driven from the likelihood of an attack-type to success (text box 240), and an attack impact on the organization vector (text box 255).

In some demonstrative embodiments, the risk assessment algorithm may use at least in part, the risk formula below for a given attack type m:

Aₘ=LₘSₘIₘ Equation 2.

Where:

Lₘ—is the likelihood to initiate attack m,

Sₘ—is the likelihood of attack success; and

Iₘ—is the impact of the attack.

In some demonstrative embodiments, a total risk calculation module 270 may receive different attack risk Aₘ and additional inputs such as, for example, risk prioritization 260 based on an organization profile 235, and external learning update 280.

In some demonstrative embodiments, the risk calculation module (270) may use weights in order to estimate the contribution of attack types m to the total risk. If A is a vector of the attack risks, and R is the vector of the total organization risk, then

$$\underline{R} = \frac{1}{N} \underline{{A}^{T}} W . \qquad Equation 3$$

Where:

W—is a weight matrix that maps between risk attacks to total operational or business risks:

$$[ \begin{matrix}{W}_{1 , 1} \\ {W}_{1 , 2} … \\ {W}_{1 , M}\end{matrix} ]$$

Reference is now made to FIG. 3, which is a schematic illustration of a two-dimensional clustering map 300, in accordance with some demonstrative embodiments.

In some demonstrative embodiments, the clustering algorithm may calculate the motivation of the attacker to perform a cyber attack on the organization. The clustering algorithm may divide the estimated value range into nine discrete values, which may be displayed as a two-dimensional clustering map 300. The two-dimensional clustering map 300 may include two indicators: potential attacker interest indicator 320 and attacker view indicator 310. For each pair of values, the appropriate cell is picked, and the cell value may be chosen to be the attacker motivation value.

For example, the attacker motivation value for organization A 330 is 7, which is a high motivation to perform a cyber-attack on organization A 330.

For example, the attacker motivation value for organization B 340 is 5, which is a medium motivation to perform a cyber-attack on organization B 340.

For example, the attacker motivation value for organization C is 1, which is a low motivation to perform a cyber-attack on organization C 350.

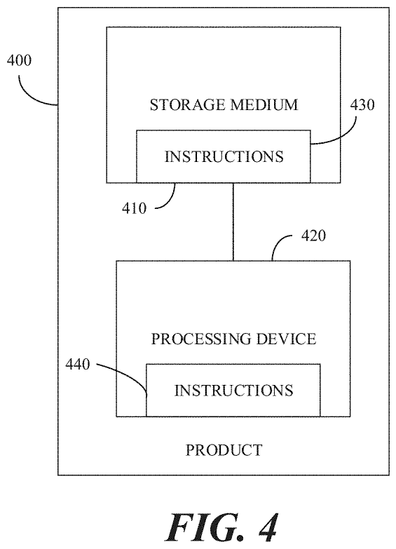

Reference is now made to FIG. 4, which is a schematic illustration of a product of manufacture 400, according to some demonstrative embodiments. Product 400 may include one or more tangible computer-readable non-transitory storage media 410, which may include computer-executable instructions 430, implemented by processing device 420, operable to, when executed by at least one computer processor, enable the at least one processing circuitry 105 (FIG. 1) to implement one or more program instructions for providing a dynamic risk assessment which enables an organization to protect his data against cyber attacks, as described above with reference to FIGS. 1-3. The phrase “non-transitory machine-readable medium” is directed to include all computer-readable media, with the sole exception being a transitory propagating signal.

In some demonstrative embodiments, product 400 and/or machine-readable storage medium 410 may include one or more types of computer-readable storage media capable of storing data, including volatile memory, nonvolatile memory, removable or non-removable memory, erasable or non-erasable memory, writeable or re-writeable memory, and the like. For example, machine-readable storage medium 410 may include any type of memory, such as, for example, RAM, DRAM, ROM, programmable ROM (PROM), erasable programmable ROM (EPROM), electrically erasable programmable ROM (EEPROM), Flash memory, a hard disk drive (HDD), a solid-state disk drive (SDD), fusen drive, and the like. The computer-readable storage media may include any suitable media involved with downloading or transferring a computer program from a remote computer to a requesting computer carried by data signals embodied in a carrier wave or other propagation medium through a communication link, e.g., a modem, radio, or network connection.

In some demonstrative embodiments, processing device 420 may include logic. The logic may include instructions, data, and/or code, which, if executed by a machine, may cause the machine to perform a method, process and/or operations as described herein. The machine may include, for example, any suitable processing platform, computing platform, computing device, processing device, a computing system, processing system, computer, processor, or the like, and may be implemented using any suitable combination of hardware, software, firmware, and the like.

In some demonstrative embodiments, processing device 420 may include or may be implemented as software, firmware, a software module, an application, a program, a subroutine, instructions, an instruction set, computing code, words, values, symbols, and the like. Instructions 740 may include any suitable types of code, such as source code, compiled code, interpreted code, executable code, static code, dynamic code, and the like. Instructions may be implemented according to a predefined computer language, manner or syntax, for instructing a processor to perform a specific function. The instructions may be implemented using any suitable high-level, low-level, object-oriented, visual, compiled and/or interpreted programming languages, such as markup language, HTML, XML, JSON, C, C++, C#, Java, Python, BASIC, Perl, Prolog,assembly language, machine code, and the like.

It is to be understood that the system and/or the method for generating a web page code that enables a user to interact with the web page by using non-visual commands is described hereinabove by way of example only. Other embodiments may be implemented base on the detailed description and the claims that followed.

It is to be understood that like numerals in the drawings represent like elements through the several figures and that not all components and/or steps described and illustrated with reference to the figures are required for all embodiments or arrangements.

It should also be understood that the embodiments, implementations, and/or arrangements of the systems and methods disclosed herein can be incorporated as a software algorithm, application, program, module, or code residing in hardware, firmware, and/or on a computer useable medium (including software modules and browser plug-ins) that can be executed in a processor of a computer system or a computing device to configure the processor and/or other elements to perform the functions and/or operations described herein.

It should be appreciated that according to at least one embodiment, one or more computer programs, modules, and/or applications that when executed perform methods of the present invention need not reside on a single computer or processor but can be distributed in a modular fashion amongst a number of different computers or processors to implement various aspects of the systems and methods disclosed herein.

Thus, illustrative embodiments and arrangements of the present systems and methods provide a computer-implemented method, computer system, and computer program product for processing code(s). The flowchart and block diagrams in the figures illustrate the architecture, functionality, and operation of possible implementations of systems, methods, and computer program products according to various embodiments and arrangements. In this regard, each block in the flowchart or block diagrams can represent a module, segment, or portion of code, which comprises one or more executable instructions for implementing the specified logical function(s).

It should also be noted that, in some alternative implementations, the functions noted in the block can occur out of order noted in the figures. For example, two blocks shown in succession may be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by particular purpose hardware-based systems that perform the specified functions or acts, or combinations of specialized purpose hardware and computer instructions.

The terminology used herein is to describe particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein is meant to encompass the items listed thereafter and equivalents thereof as well as additional items.

Functions, operations, components, and/or features described herein with reference to one or more embodiments may be combined with or may be utilized in combination with one or more other functions, operations, components, and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. A method for generating a dynamic cyber risk assessment by a computer system comprising processing circuitry configured to process the method, the method comprising:
receiving data related to an organization network exposure to a possible cyber-attack, wherein the data is received from one or more external data sources and one or more internal data sources;
processing the data to produce one or more measures for one or more data types, wherein a data type of the or more data type includes one or more parameters related to the organization network exposure to the possible cyber-attack; and
calculating a cyber risk assessment vector of the organization based on one of the one or more measured data types.

2. The method of claim 1, wherein the processing comprises:
calculating a score to the data type m by a risk assessment algorithm, wherein the calculation is done according to:
Aₘ=LₘSₘIₘ
Where:
Lₘ—is the likelihood to initiate attack m,
Sₘ—is the likelihood of attack success; and
Iₘ—is the impact of the attack.

3. The method of claim 4, wherein processing the data comprises:
estimating the contribution of a data type m to a cyber-attack risk estimation by assuming that if A is a vector of the attack risks, and R is a vector of a total organization risk, then
$$\underline{R} = \frac{1}{N} \underline{{A}^{T}} W$$
Wherein:
W—is a weight matrix that maps between risk attacks to total operational or business risks:
$$[ \begin{matrix}{W}_{1 , 1} \\ {W}_{1 , 2} … \\ {W}_{1 , M}\end{matrix} ]$$

4. The method of claim 1, wherein processing is done by a risk assessment algorithm and comprises:
providing a security protection score to the data type based on a portion of the received data collected by an automated questionnaire.

5. The method of claim 1, wherein processing is done by a risk assessment algorithm and comprises:
providing an impact assessment as a measure of a cyber-attack risk impact based on the automated questionnaire inputs.

6. The method of claim 1, wherein the processing comprises:
receive a cyber-attack type, and to generate one or more cyber-attack vectors based on the cyber-attack type.

7. The method of claim 6, wherein processing is done by a risk assessment algorithm and comprises:
receiving attacker view information data, protection measures data, organization profile data.

8. The method of claim 6, wherein processing is done by a risk assessment algorithm and comprises:
calculating the likelihood of the cyber-attack measure based on the attacker view information data.

9. The method of claim 6, wherein processing is done by a risk assessment algorithm and comprises:
calculating a likelihood of a predefined cyber attack to success based on the protection measure data.

10. The method of claim 9, wherein processing is done by a risk assessment algorithm and comprises:
calculating a likelihood of a cyber attack to success based on an external statistical calculation.

11. The method of claim 10, wherein processing is done by a risk assessment algorithm and comprises:
calculating a total risk of cyber-attack based on the likelihood of an attack-type to success and an attack impact on the organization vector.

12. The method of claim 1, comprising:
calculating a motivation of an attacker to perform a cyber attack on the organization based on a potential attacker interest indicator and an attacker view indicator.

13. The method of claim 12, wherein the motivation of the attacker comprises one or more levels of motivation.

14. A product comprising one or more tangible computer-readable non-transitory storage media comprising program instructions for generating a map of subsurface wherein execution of the program instructions by one or more processors comprising:
receiving data related to an organization network exposure to a possible cyber-attack, wherein the data is received from one or more external data sources and one or more internal data sources;
processing the data to produce one or more measures for one or more data types, wherein a data type of the or more data type includes one or more parameters related to the organization network exposure to the possible cyber-attack; and
calculating a cyber risk assessment vector of the organization based on one of the one or more measured data types.

15. The product of claim 14, wherein execution of the program instructions by one or more processors comprising:
calculating a score to the data type m by a risk assessment algorithm, wherein the calculation is done according to:
Aₘ=LₘSₘIₘ
Where:
Lₘ—is the likelihood to initiate attack m,
Sₘ—is the likelihood of attack success; and
Iₘ—is the impact of the attack.

16. The product of claim 14, wherein execution of the program instructions by one or more processors comprising:
estimating the contribution of a data type m to a cyber-attack risk estimation by assuming that if A is a vector of the attack risks, and R is a vector of a total organization risk, then
$$\underline{R} = \frac{1}{N} \underline{{A}^{T}} W$$
Wherein:
W—is a weight matrix that maps between risk attacks to total operational or business risks:
$$[ \begin{matrix}{W}_{1 , 1} \\ {W}_{1 , 2} … \\ {W}_{1 , M}\end{matrix} ]$$

17. A computer system tor generating a dynamic cyber risk assessment comprising processing circuitry which is configured to:
receive data related to an organization network exposure to a possible cyber-attack, wherein the data is received from one or more external data sources and one or more internal data sources;
process the data to produce one or more measures for one or more data types, wherein a data type of the or more data type includes one or more parameters related to the organization network exposure to the possible cyber-attack; and
calculate a cyber risk assessment vector of the organization based on one of the one or more measured data types.

18. The computer system of claim 17, wherein the processing circuitry is configured to:
calculate a score to the data type m by a risk assessment algorithm, wherein the calculation is done according to:
Aₘ=LₘSₘIₘ
Where:
Lₘ—is the likelihood to initiate attack m,
Sₘ—is the likelihood of attack success; and
Iₘ—is the impact of the attack.

19. The computer system of claim 17, wherein the processing circuitry is configured to:
estimate the contribution of a data type m to a cyber-attack risk estimation by assuming that if A is a vector of the attack risks, and R is a vector of a total organization risk, then
$$\underline{R} = \frac{1}{N} \underline{{A}^{T}} W$$
Wherein:
W—is a weight matrix that maps between risk attacks to total operational or business risks:
$$[ \begin{matrix}{W}_{1 , 1} \\ {W}_{1 , 2} … \\ {W}_{1 , M}\end{matrix} ]$$

20. The computer system of claim 17 wherein the processing circuitry is configured to process a risk assessment algorithm to:
provide a security protection score to the data type based on a portion of the received data collected by an automated questionnaire;
provide an impact assessment as a measure of a cyber-attack risk impact based on the automated questionnaire inputs;
receive a cyber-attack type, and to generate one or more cyber-attack vectors based on the cyber-attack type;
receive attacker view information data, protection measures data, organization profile data and calculate the likelihood of the cyber-attack measure based on at least one of the attacker view information data;
calculate a likelihood of a predefined cyber attack to success based on the protection measure data;
calculate a likelihood of a cyber attack to success based on an external statistical calculation; and
calculate a total risk of cyber-attack based on the likelihood of an attack-type to success and an attack impact on the organization vector.
